(19) United States
(12) Patent Application Publication
(10) Pub. No.: US 2014/0067658 A1
(43) Pub. Date: Mar. 6, 2014

(54) INTERNET OPERATING SYSTEM AND METHOD

(71) Applicant: Hassen Damon Alhandy, Sylvania, OH (US)

(72) Inventor: Hassen Damon Alhandy, Sylvania, OH (US)

(21) Appl. No.: 13/833,727

(22) Filed: Mar. 15, 2013

Related U.S. Application Data
(60) Provisional application No. 61/697,405, filed on Sep. 6, 2012.

(51) Int. Cl. H04L 29/08; G06Q 50/00

(52) U.S. Cl. CPC H04L 67/306; G06Q 50/01
USPC 705/39; 709/204

(57) ABSTRACT

A computer-implemented social networking method includes a step of maintaining in a computer system a plurality of social network applications. Each of the social network applications includes a topic having a goal and a title, and is displayed in a graphical user interface. A plurality of users is permitted to join one of the social network applications. Each of the users has a virtual user card with user information that meets threshold requirements set by an owner of the one of the social network applications joined by the users. An adoption of the one of the social network application joined by the users is allowed by the computer system. Control of the social network application is transferred by the adoption from the owner to an adoptive user.

### CROSS-REFERENCE TO RELATED APPLICATIONS

This application claims the benefit of U.S. Provisional Application No. 61/697,405, filed on Sep. 6, 2012. The entire disclosure of the above patent application is hereby incorporated herein by reference.

### FIELD OF THE INVENTION

The present disclosure relates to social networks and, more particularly, a social networking system and method for facilitating having like or similar interests.

### BACKGROUND OF THE INVENTION

Individuals have historically networked with one another by joining social clubs, attending social events, meeting friends through other friends, and so forth. The Internet has made keeping in touch with friends and acquaintances more convenient for many people. For other people, the Internet provides a social forum for networking and meeting new people.

Internet users employ social networking to communicate with friends, family, acquaintances and people who may have similar interests, for example, by sharing photos, videos, and messages either publically for all of their network and possibly the Internet to see, or privately from one person to another. A system providing internal competition has yet to be created that influences search results while providing users with exclusivity, user evaluations, user creation evaluations and user creation evaluations within specific industries.

In order to facilitate communications between the vast numbers of individuals, various social networking websites have developed in recent years. Social networking websites can provide organizational tools and forums for allowing these individuals to interact with one anther via the social networking website. Many users prefer to limit communications to specific groups of other users.

Search engines structured around social networking allow users to search by people or interest. One example of known search engines is operated by Google Inc., which maintains the particular search algorithm as a trade secret. Other types of search engines are employed within social networking systems themselves, such as Facebook.com, and are also known.

Known social networking websites have primarily been developed in a linear way, linking one user-created profile to another user-created profile. Search engines such as Google.com, social networks such as Facebook.com and Google+.com, domain services such as Godaddy.com, and group buying sites such as Groupons.com have all been profitable but are limited by this linear structure.

There is a continuing need for an improved social networking system and method for facilitating competition through evaluating of a network of individuals having like or similar interests, with users being able to dictate prerequisite authorization for member acceptance, thereby ensuring members with the desired attributes are the participants.

### SUMMARY OF THE INVENTION

In concordance with the instant disclosure, an improved social networking system and method for facilitating competition through evaluating of a network of individuals having like or similar interests, with users being able to dictate prerequisite authorization for member acceptance, thereby ensuring members with the desired attributes are the participants, is surprisingly discovered.

Entrepreneurs have heretofore been unable to satisfactorily achieve goals in industry's germane to their interests using known social network environments. Social networking, search engine results, user communication and user account management across all platforms on the Internet are limiting in this respect. The platform of the present disclosures provides a unique way for users to develop, communicate, search, manage and achieve, and thereby achieve their goals. The platform is a social Internet operating system that users can employ to manage their own created or joined social networks, with the ability to search for other user created social networks to join or request to join by popularity.

The present disclosure includes a social networking, web development, group buying, search engine that allows users the ability to create multiple social network applications, declare how the social network applications will be used, and capitalize on the power of numbers. The platform creates an online identity while adding validity, privacy and an evaluation to user created business networks, by allowing users the ability to charge for membership. Users are also allowed to exchange ownership of a network from user-to-user, and exchange money for group acquisitions.

More particularly, the present disclosure includes a search engine and user created social networking platform that provides people a tool to create their own “end user created group buying networks” in any industry through unique social network structure and competition. This user created social web development tool provides privacy, exclusivity and validity, allowing users to keep their created and joined social networking activities separate and profitable.

Social Internet Operating System Description:

This social environment acts as a social Internet operating system, allowing a user to create and join social networks and/or social network profile environments. The environment allows users to declare financial obligations for membership as well as exclusivity, features and privacy. The platform allows users the ability to apply various elements of social networking to banking and purchasing through user-to-user and user-to-multiuser transactions within a social environment. Users can create or join environments of their choice.

Using the system and method of the present disclosure, the power of social network customization will be taken to the next level within a maintained and controlled environment. With an initial particular focus on college segmentation, the platform may be available to people who are not students; however, they will not be included in the .edu email registration default segmented Interest on the platform. The platform distinguishes students from non-students by the email address registered. Where a user registers an .edu email address, they are required to fill out five pieces of information on the user card: first and last name; university; major; and expected year of graduation. This is how the default segmentation for students is generated within each user's interest within each student's account. The default segmentation is a social network that groups users together by university and major otherwise known as the “Default Interest”. As the platform grows, students may later be provided with a default segmentation of university, major and expected graduation year. This may be implemented at larger schools when the user base within a default segment reaches a certain number. Non-students will have the opportunity to join this platform, but they may or may not be offered a default segmentation.

A platform user can create a social network environment and it is know as creating an “Influence”. Users can select various card elements, various features, choose from various privacy settings, declare search words in the form of a title, description, goal and purpose, and set financial obligations when creating the Influence.

Product and Service Description:

A user created social networks, also referred to herein as UCSN, all have a local, national and world evaluation that vary by location of the inquiry, and can be bought and sold. This social Internet operating system is described further herein, and includes Influences and Interests, segmentation, exclusivity, privacy, user-to-multiuser transactions, as well as a novel evaluation system.

Each Influence a user creates has a set of rules members must abide by when joining or requesting to join a social network profile. A user can create a social network profile by declaring search words through declaring a title, description, goal and purpose. Each Influence is a different social network profile that was created by the logged in user, which can satisfy different needs potential members may have. Each social network profile can require certain card information that the members must be willing to expose and/or share in common. Each social network profile environment can have financial obligations associated with membership by the creator and/or all the members who join. An Influence can be created for various purposes including easy collaboration on a very particular topic or for user to multi user transactions.

The social Internet operating system's structure opens the door for social networking in several segments that include business, career, friends, family, and all current market segments with unlimited potential for users to capitalize on opportunities. The social Internet operating system allows its users to generate the social network without knowledge of programming. A social network profile is given user control over financial obligations, search elements, exclusivity, privacy and features.

Adoption: The process of transferring ownership of a social network from one user to another that may or may not be in exchange for a fanatical prerequisite.

Partnership: The process of joining together two separate social networks owned by two separate users.

Merger: The process of combining two previously separate social networks owned by the same person.

Below is a non-limiting process of creating a social network:
Declare title, name, description, purpose, and goal;
Set financial obligations and requirements for membership;
Set virtual user card thresholds;
Set privacy policy; and
Set features,

Privacy Policy Part 1: Social Network Creation.

A social network profile can be set to allow anyone to join who meets the card threshold requirements set by the owner. A social network profile can be discoverable by search engine and unique identifier or undiscoverable by search engine and discoverable by unique identifier. Finally, the creator or owner may also decide to render the social network a “Ghost,” which means it will not pull up when searched for by the unique identifier or in search engine results. A user cannot declare the social network a “Ghost” without having at least one member, and must also have a unanimous approval by all members.

Privacy Policy Part 2: Virtual User Card Thresholds.

The owner has the ability to set the required virtual user card information thresholds that members must be able to provide in order to join the social network. The information required sets the prerequisites for acceptance, requiring virtual card information to match and/or requiring card information be made available to the owner and/or members.

Privacy Policy Part 3: Within a Social Networks.

Privacy Blocks are different permissions a user and/or owner have within a social network profile environment. Privacy blocks give the owner and members control over privacy, features, settings, user communication and more.

User Benefits:

The user has a multitude of benefits on this platform. Another way Social Internet operating system describes user benefits is by problems solved. Social Internet operating system gives users the ability to group segments of people and themselves properly achieving extreme exclusivity, privacy and control. User segmentation is structured around applying transaction capabilities to groups of people who share similar interests. The platform provides a segment of users on the platform with a default segmentation. Users have the ability to make a user created social network as expensive and exclusive as desired, without coding knowledge, and declare the user created social network will be used and by whom. Creations can be used to leverage the groups' size in any industry.

Users do not need programmers when creating custom social network websites. The owner is able to customize the social network with members having the desired geographic location, demographics and psychographics of members who join.

College enrollment will now hold a value as it relates to the platform. Students have a distinct advantage on this platform and that is the ability to be segmented by university and major. Students will have the ability to meet people they do not know, and turn rivals and competitors into allies by networking with the people they will be competing with across the nation. Students can find out about available positions all over the country, and create segmented social networks of value. Students can also grow their created social networks by soliciting people in their default segmentation.

Users are able to financially benefit from their creations by charging users to join their created social networks. They will also be able to capitalize on creations through marketing, advertisement, group buying and the sale of their creations in the process of adoption.

Competitive Advantage:

This initial segmentation will allow users who do not know each other the ability to meet or people who just meet the ability to socialize, collaborate over common interest by exchanging information without being in the same place. Get to know the people you don't know and collaborate/communicate easily over your common interests privately or publically by creating groups of segmented value.

Users can leverage their owned, segmented social networks for profit by selling their created social networks or by leveraging the size to advertisers and companies and for group buying opportunities.

Social Internet operating system gives users privacy and exclusivity over other social network websites. Users can elect to participate in different social network profiles with or without owner approval, with each social network remaining separate and confidential from one another and holding different evaluations.

Social Internet operating system evaluates users, user creations, platform creations for group buying, marketing, searching and resale opportunities.

Social Internet operating system has a geographic search advantage over other social network websites.

Social Internet operating system structures a search by evaluating user created social networks by the amount of members it has, and the location of the members to the location the search inquiry was made from.

Each user created social network holds an evaluation and is evaluated differently by the location a search inquiry is made for multiple search options including but not limited to local and national searches by members. This allows users to see the individual value a social network has to the individual who has made the search inquiry.

The search also allows users to view results of social networks created locally, nationally and globally and orders results by social network evaluations.

A user card allows creators to dictate the information required from members who join making each social network profile a group of people within the desired demographic, psychographic, geographic location and lifestyle choices. The card information seeking protection should not be limited to the information available upon release or anytime thereafter as it will constantly evolve.

The owner can require user-to-user transactions and user-to-multiuser transactions within an owned and operated environment.

Concept Description:

This is a social network that will be used by everyone in every industry on a daily basis. Users will use a social network they can financially benefit from over one that financially benefits its self, founders, investors and employees. Social Internet operating system will provide users the ability to capitalize on the service provided in a way that all other social networks are incapable of providing. The power of social network customization will be taken to the next level within a maintained and controlled environment. Initially students will have access to other students at their universities within their major. Later school segments may be presented that allow nation-wide segmentation by major university and expected graduation year or within major university and expected graduation year by conference. This information is entered by the student themselves onto their card.

Influence and Interest:

Influence and Interest refers to an individual user and his or her owned or join social network profiles. An Influence is a social network that the user has either created or owns and has made available to others allowing the social network profile to acquire joiners or members. An interest is a social network that the user has joined and brought into his network. A member can disassociate association with a social network he has joined by removing it as an interest. A Social network profile owner can remove individual members from his owned environment. The exclusivity of any social network is completely up to the creator of the social network and is something the people who wish to join must consider.

Activity Tab:

This category shows a running tab of social network activity and communication. A notification under the activities tab includes the following information lets a user see important notifications, messages, activity, approvals, requests and more of owned and joined social network profiles

Related Products and Services:

User will have access to an operating system install that can be install on a computer as well as software that can be installed on an existing OS allowing users to turn computers into their own online social networking cloud service environment from any computer they use. Users will have the ability to download data from their Vault to the hard drive of the computer they are using. Users will also be able to upload data from the hard drive of the computer they are using to their vault allowing multiple users the ability to use different machines they come across as their own personal social networking operating system environment regardless of location.

Provide a downloadable software that would allow users to have their website included in our search results by placing an evaluation on websites by the amount of links it has to various social network users.

Mobile platform creation

WiFi Ads

Browser creation

OS creation for desktops

Enter communications

Enter devices

Technology Used:

In one embodiment, a computer-implemented social networking method includes a step of maintaining in a computer system a plurality of social network applications. Each of the social network applications includes a Title, Description and a Goal and Purpose, and is displayed in a graphical user interface. A plurality of users is permitted to join one of the social network applications. Each of the users has a virtual user card with user information that meets threshold requirements set by a first owner of the one of the social network applications joined by the users. An adoption of the one of the social network application joined by the users is allowed by the computer system. Control of the social network application is transferred by the adoption from the first owner to a second owner. The immediate needs and concerns this concept faces can be elevated by programmers. The programmer must possess knowledge of PHP, Java, SQL and/or MYSQL. Also Social Internet operating system will need a location that Haas Damon would be able to provide if necessary. The chosen facility must be secure both physically and electronically. Users will be able to use the services of Social Internet operating system on any and all platforms through graphical user interfaces on iPads, iPods, iPhones, desktops, laptops Android and any device that connects to the Internet. Other types of devices with graphical user interfaces may also be employed, as desired.

In another embodiment, a computerized social networking system includes a social network application editor module, a social network application module, and an adoption module. The social network application editor module is configured to maintain in a computer system a plurality of social network applications to be joined by users of the social network. Each of the social network applications includes a topic having a goal and a title, and is displayed in a graphical user interface. The social network application module is configured to permit a plurality of users to join one of the social network applications. Each of the users has a virtual user card with user information that meets threshold requirements set by a first owner of the one of the social network applications joined by the users. The adoption module is configured to allow an adoption of the one of the social network application joined by the users. Control of the social network application is transferred by the adoption from the first owner to a second owner.

In a further embodiment, a computer readable storage medium has tangibly embodied thereon a program of instructions executable by a processor for performing the computer-implemented social networking method.

In an alternative embodiment, a computer-implemented social networking method includes a step of allowing one of the users to login to the computer system. Upon logging into the computer system the one of the users is shown the plurality of social network applications limited to an initial segmentation based upon an algorithm. The algorithm compares the virtual user card of the user logging into the computer system to available ones of the plurality of social network applications.

### DRAWINGS

The above, as well as other advantages of the present disclosure, will become readily apparent to those skilled in the art from the following detailed description, particularly when considered in the light of the drawings described hereafter.

FIG. 1 is a high level visual description of the separate components of the platform, according to one embodiment of the present disclosure;

FIGS. 2A-2C show a relationship a user's card and vault have with social networks on the platform, with connections between the figures identified by circled letters A-C;

FIG. 3 depicts a search algorithm according to the present disclosure;

FIG. 4 shows a privacy policy of social networks;

FIGS. 5A-5B illustrate a social network information page (SNIP), what's on it, and what information can be seen when a social network is selected after it is searched;

FIGS. 6A-6B are a high level visual description of a user's owned social networks and the relationship they have with other users and components found on the platform, with connections between the figures identified by circled letters A-R;

FIGS. 7A-7B are a high level visual description of a user's joined social networks and the relationship they have with other users and components found on the platform, with connections between the figures identified by circled letters A-L;

FIG. 8 shows an adoption, the process of a social network switching ownership from one user on the platform to another;

FIG. 9 shows a partnership, the process of combining the members of two separate social networks together into one with both social networks having a different owner;

FIG. 10 shows a merger, the process of combining the members of two separate social networks together into one with both social networks having the same owner;

FIGS. 11A-11B show a creating of an account page, and particularly the elements college students will be asked when creating an account and can be segmented in various ways by providing this information;

FIG. 12 shows a social search page, and particularly the elements a search engine will have and the search structure;

FIG. 13 illustrates an exemplary environment for the platform of the present disclosure;

FIG. 14 is a block diagram of an exemplary platform according to the present disclosure; and

FIG. 15 is a flow diagram of an exemplary process using the platform according to the present disclosure.

### DESCRIPTION OF THE ELEMENTS IN THE SPECIFICATION AND DRAWINGS

Elements of the Drawings:

1—USER: An Individual who creates an account.

2—INFLUENCE: A category of created social networks.

3—INTERESTS: A category of joined social networks.

4—VAULT: Holds uploaded user data such as but not limited to pictures, videos, text boxes, files and other data. Secure storage (e.g., by user name and password) with content provided by the user.

5—CARD: Contains information about a user.

6—PVTFD: Abbreviation for Vault information. Pictures, Videos, Textboxes, Files, Data.

7—SN: Stand for “Social Networks” that includes but not limited to UCSN,

CCSNO, CCSNR and Default.

8—UCSN: Refers to User Created Social Networks.

9—DEFAULT: Refers to the platforms default segmented social networks given to registered students and professors that groups users together by university and major.

10—CCSNR: Refers to Company Created Social Networks Required. These are company created social networks that will appear in a user's influences that users are a member of. Can be used as paid advertisement and our pay to influence growth on the platform.

11—CCSNO: Refers to Company Created Social Networks Optional. These are company created social networks that will be offered to platform users, user would be able to decide if they would like to join. Can be used as paid advertisement and our pay to influence growth on the platform.

12—UI, “User Influence”, Refers to the amount of users a user has access to through owned social networks categorized under Influences only counting users once regardless if a user has a member that is a member in multiple influences.

13—TSNI: “Total Social Network Influence”, Refers to the amount of users a user has access to through owned social networks categorized under Influences. Each member of each social network is counted regardless if the member is a member of multiple social networks

14—SNI: “Social Network Influence”, Refers to the amount of members a UCSN has.

15—SS: “Social Stock”, refers to an evaluation of a UCSN whereas the SNI is divided by the amount of UCSNs that have been created with the same search words or phrase declared. This evaluation can be conducted locally, nationally and globally with the denominator in the fraction changing to the amount of social networks created locally for a local evaluation, nationally for a national evaluation and globally for a global evaluation.

16—Adoption: The process of transferring ownership of a social network from one user to another.

17—Partnership: The process of joining together two separate social networks owned by two separate users.

18—Merger: The process of combining two previously separate social networks owned by the same person.

19—Open: A social network discoverable by internal and external search engine, findable by unique identifier and any user may join who meets Card 5 thresholds.

20—Exclusive: A social network discoverable by internal and external search engine, findable by unique identifier and a request to join approval from the User 1 owner or an invitation by a User 1 owner is required for membership as well as met Card 5 thresholds.

21—Private: A social network undiscoverable by search engine, discoverable by unique identifier and a request to join approval from the User 1 owner or an invitation by a User 1 owner is required for membership as well as met Card 5 thresholds.

22—Ghost: A social network can become a Ghost with the approval of all members who have met Card 5 thresholds. A Ghost is undiscoverable by search engine, undiscoverable by unique identifier and no members can join.

24—SNIP: Social Network Information Page: Refers to the page that can be viewed after a search is conducted and a result is selected.

25—SA: Search Algorithm: Orders results by the amount of members associated with a page that has declared the same or similar search words as the inquiry made.

26—LMSNI: Local Search for Social Networks by members location and ordered by SNI from greatest to least.

27—LLSNI: Local Search for Social Networks by Location and size.

28—NMSNI: National Search for Social Networks by members location and ordered by SNI from greatest to least.

29—NLSNI: National Search for Social Networks by Location and size.

30—WMSNI: World search for social networks by members SNI.

31—WLSNI: World search for social networks by size.

100—Computerized social networking system.

102—Social Internet operating system.

104—Network, for example, the Internet.

106—User Device.

200—Social Networks Module.

202—Processing Module.

204—User Module.

206—Editor Module.

208—Transactions Module.

210—Adoption Module.

300—Computer Implemented Social Networking Method.

302—Step Creating A Social Networking Application.

304—Step Setting Threshold Requirements To Join Social Networking Application.

306—Step Permitting User to Join Social Networking Application.

308—Step Determining SNI For All Social Networking Applications.

310—Step Permitting Keyword Search of All Social Networking Applications.

312—Step Displaying Search Results Ordered by SNI.

314—Step Allowing User Or Owner To Solicit Adoption Of Social Networking Application.

316—Step Transferring Ownership of Social Networking Application Through Adoption.

318—Step Permitting The Owner and Another Owner to Join Social Networking Application in a Partnership.

320—Step Permitting the Owner to Merge a Pair of the Owner's Social Networking Applications.

### DETAILED DESCRIPTION OF THE INVENTION

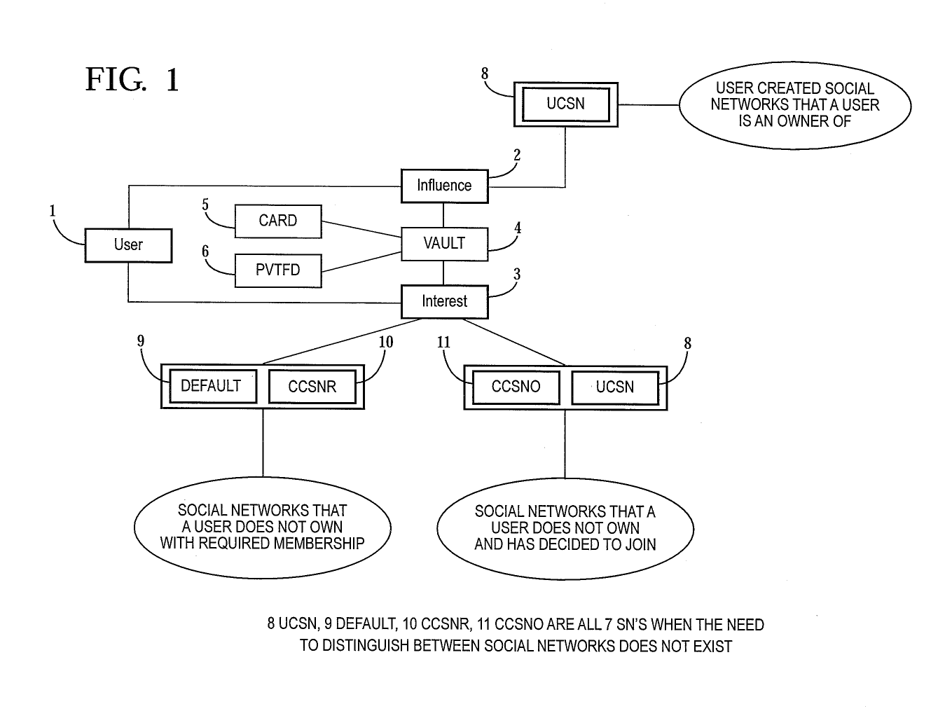

FIG. 1: “Relationship of Platform Elements”

A relationship of Users 1 to various elements on the platform is shown in FIG. 1. The drawing shows a high level view revealing the Users' 1 environment. A User 1 has two categories: Influence 2; and Interest 3. The drawing shows how Influence 2 holds UCSNs 8, and Interests 3 hold different SNs 7, including UCSN 8, Default 9, UCSNR 10 and UCSNO 11. Each SN 7 has a relationship with the Vault 4, the Card 5 and PVTFD 6 providing the SNs 7 within an Interest 3 or Influence 2 within a User's 1 account. The Default 9 is a social network given to Users 1 who register an .EDU email address and groups them by University and Major and appears as an Interest 3 in a Users 1 account.

As used herein, the SN 7 includes a customized and/or individualized (within the constraints of the Social Internet operating system format) webpage or website for communication with friends, family, acquaintances and people who may have similar interests, for example, by sharing content such as text, audio, photos, videos, etc. In addition to the owner being able to share content, the owner of the SN 7 may opt to permit members of the SN 7 to also share content.

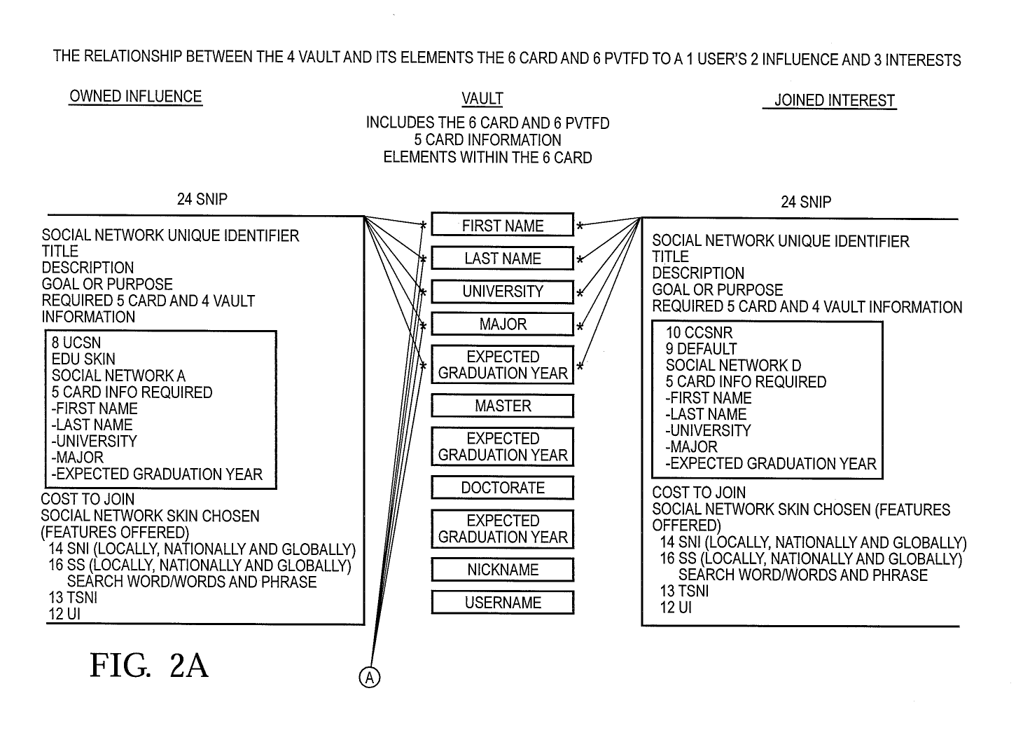

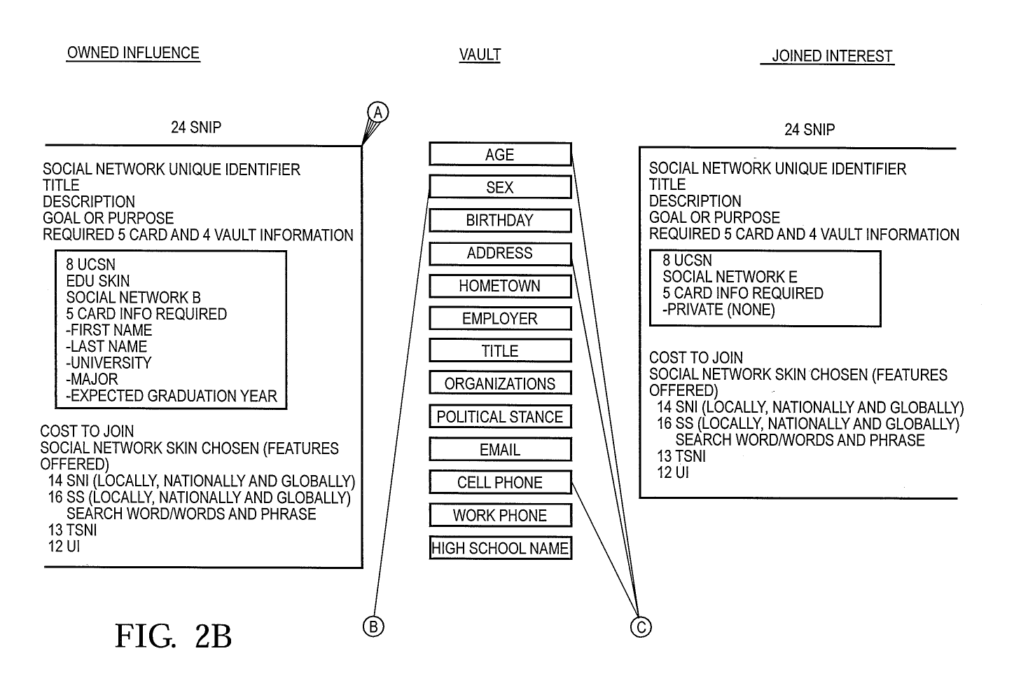

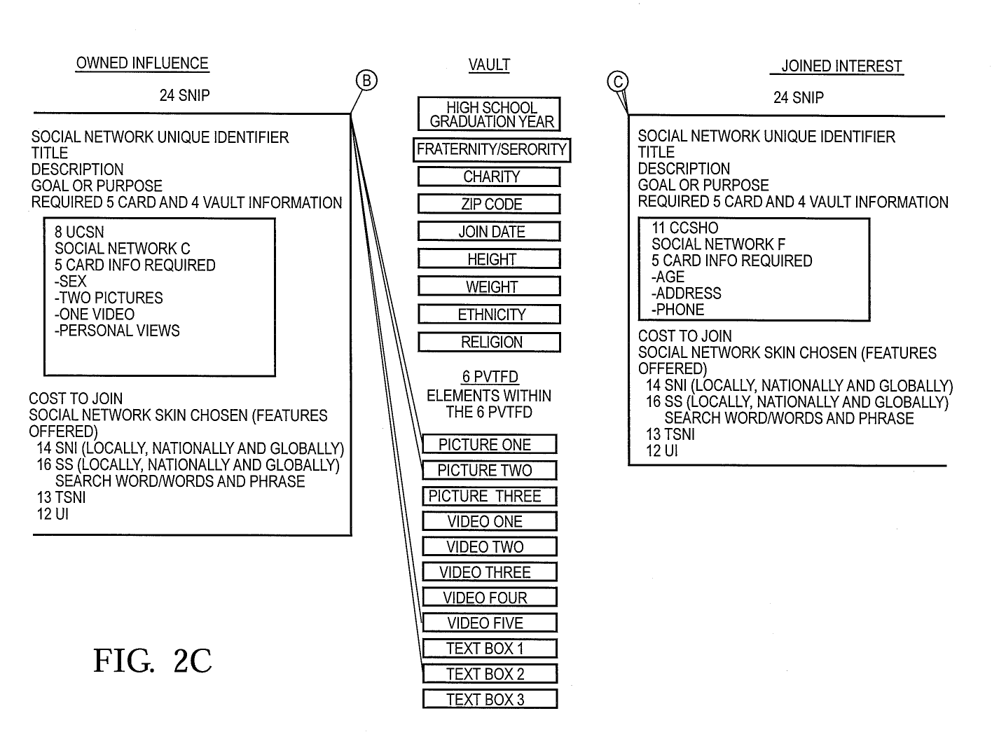

FIGS. 2A-2C: “Relationship of Card 5 and Vault 4 to SNs 7”

A User's 1 Card 5 located within the Vault 4 allows for premier segmentation within the SN 7 that the User 1 owns. This provides the User 1 with social networks of segmented value. Members of the SN 7 made the set Card 5 elements required for membership available to the SNs 7 owner and/or members upon joining. Elements within the PVTFD 6 found within the Vault 4 may be made available to various joined SNs 7 with or without owner approval. The User 1 owner of SNs 7 can make specific elements in the PVTFD 6 available to the members of the SN 7. FIGS. 2A-2C show information that can be found on a Card 5 and within the Vault 4 but is not limited to the information shown. The Card 5 information is set by the owner and data within PVTFD 6 can be uploaded to an SN 7 by members with owner approval. The Vault 4 has new options for Users 1 to create new segmented SNs 7. Financial transactions between the members of the SN 7 and the owner of the SN 7 are permitted. This gives the platform various advantages including, but not limited to, prerequisite verification, credibility, authentication, authorization and validity and financial opportunities.

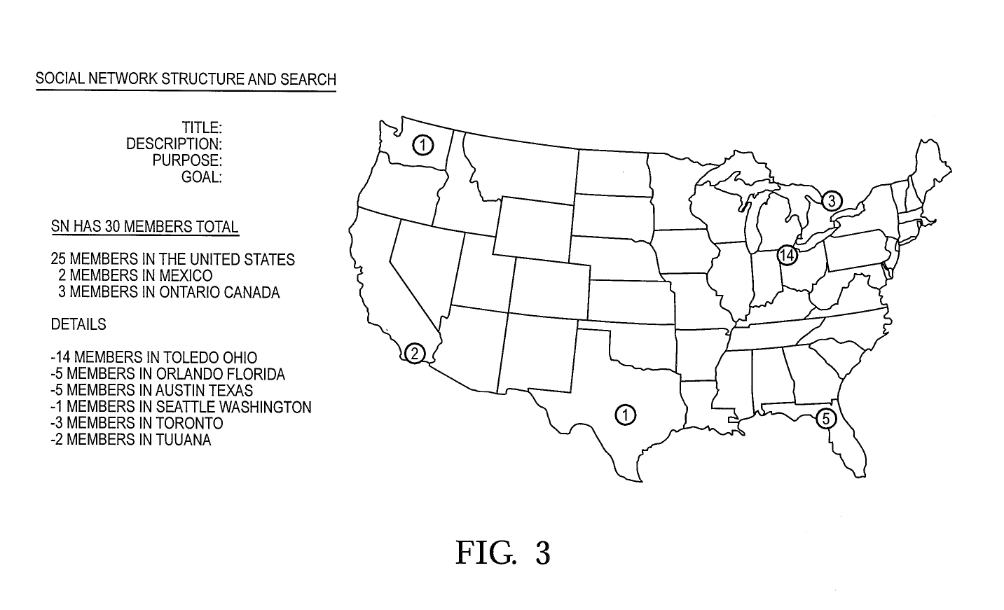

FIG. 3: “Search Algorithm”

Social Search:

User evaluations hold different forms on this platform. Forms of user evaluations include TSNI 13, the amount of members a User 1 has access to within owned UCSNs 8, and UI. UI describes the amount of actual people a User 1 has access to in all owned SNs 7, only counting individuals once regardless if the owner has the User 1 within multiple Influences 2.

Individual SNs 7 will have evaluations as well. SNI 14 refers to the amount of members within an individual SN 7. The SS 15 is a way to evaluate SNs 7 by industry and competition and location.

Social Network Influence or SNI 14 represents the amount of members a SN 7 has. The SNI 14 can be factored locally, nationally and globally two different ways.

When a search inquiry is made, results are ordered by SNI 14 from greatest to least with SN 7 that have declared the same title, description, goal or purpose as the inquiry made followed by similar or close versions of the inquiry made.

LMSNI 26: Only the members who are within a predetermined geographical location, for example, a 100 mile radius of the geographic location of the origin of the search inquiry made, may influence the SNI 14. The results are then ordered greatest to least.

NMSNI 28: Only the members located in the same country as the origin of the search inquiry made influence the SNI 14. The results are then ordered from greatest to least.

WMSNI 30: Results are ordered from greatest to least without limitations to the SNI 14 of the SN 7.

LLSNI 27: Only SN 7 created within a 100 mile radius of the search inquiry made will influence the SNI 14. Results are then ordered greatest to least. This search will be independently available as well as available after an LMSNI 26 search is performed and after a NMSNI 28 search is performed and finally after a WMSNI 30 search is performed removing any results created outside the Users 1 home town or 100 mile radius by selecting “Local Only”.

NLSNI 29: Only SNs 7 created within the same country of origin as the inquiry made will influence the SNI 14, results are then ordered from greatest to least. This search will be independently available as well as available after an LMSNI 26 search is performed and after a NMSNI 28 search is performed removing any results created outside the User 1 home country by selecting “My Country Only” following search results.

WLSNI 31: Results are ordered from greatest to least without limitations to the SNI 14 of the SN 7.

FIG. 3 shows a particular, non-limiting example how the SNI 14 of the SNs 7 varies by the location of its members in an LMSNI 26, NMSNI 27 and a WMSNI 29 search.

The following example is predicated on the user inquiry entered in the search bar matching the search word, search words or search phrase declared by the SN 7 owner within the title, description, and goal or purpose.

A world search would cause the SN 7 evaluations to be 30 regardless of the location the inquiry was made from.

A national search conducted by a user in the US would cause the SNI 14 evaluation of the SNs 7 to be 25 regardless of the city or state the inquiry was made from.

A national search conducted by a user in Canada would cause the SNI 14 evaluation of the SNs 7 to be 3 regardless of the province or territories or city the inquiry was made from.

A national search conducted by a user in Mexico would cause the SNI 14 evaluation of the SNs 7 to be 2 regardless of the city or territory the inquiry was made from.

A national search conducted by a user outside of Canada, Mexico, and USA would cause the SNI 14 evaluation of the SNs 7 to be zero therefore not included in search results.

A local search conducted in Toledo, Ohio would cause the SNI 14 evaluation of the SNs 7 to be 14.

A local search conducted in Orlando, Fla. would cause the SNI 14 evaluation of the SNs 7 to be 5.

A local search conducted in Austin, Tex. would cause the SNI 14 evaluation of the SNs 7 to be 5.

A local search conducted in Seattle, Wash. would cause the SNI 14 of the SNs 7 evaluation to be 1.

A local search conducted in Toronto, Canada would cause the SNI 14 evaluation of the SNs 7 to be 3.

A local search conducted in Tijuana, Mexico would cause the SNI 14 evaluation of SNs 7 to be 2.

A Local search conducted outside one of the mentioned cities would cause this SNI 14 evaluation of SNs 7 to be 0, and therefore not included in search results.

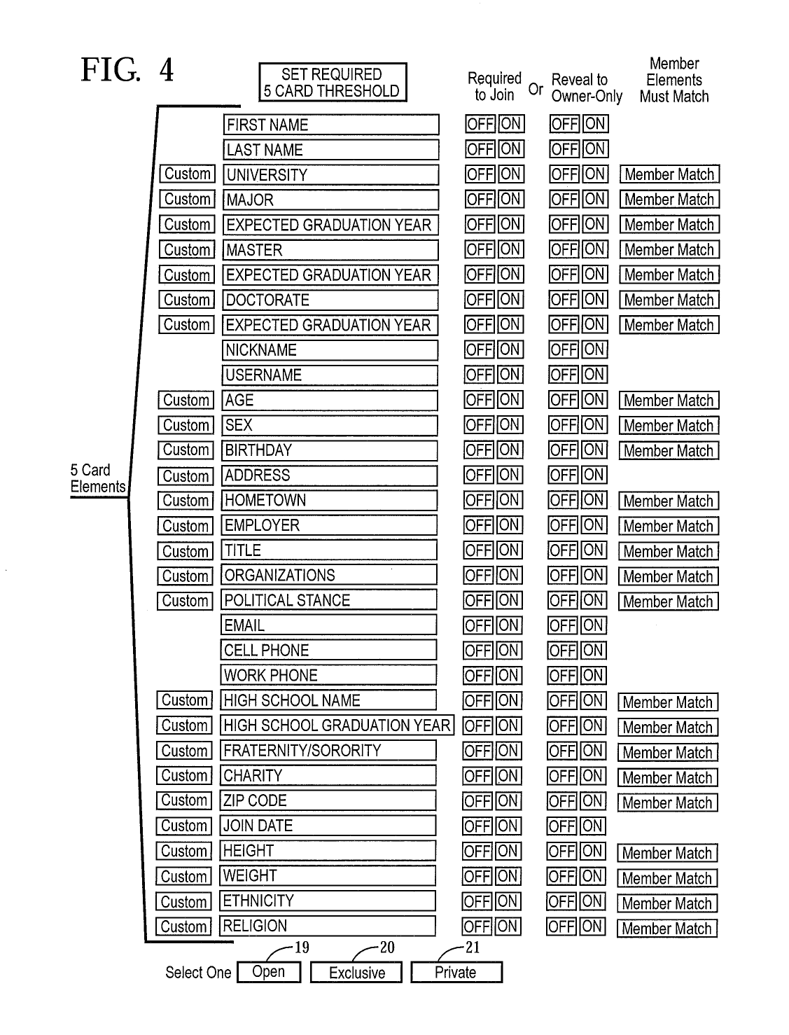

FIG. 4: “Privacy Policy of SNs 7”

Privacy enhancements initiated through the Vault 4's Card 5 settings.

The User 1 owner of the SN 7 has the ability to dictate the privacy of the SN 7 by dictating which elements shown in the Card 5 are required by the members who choose to join or request to join the SN 7, as shown in FIG. 4. The User 1 owner of the SN 7 has the ability to dictate Custom Card 5 elements required for membership. The User 1 owner of the SN 7 has the ability to dictate which Card 5 elements required for membership are exposed to the members of the SN 7. The User 1 owner of the SN 7 has the ability to dictate which Card 5 Elements required for membership are exposed to only the owner of the SN 7. The User 1 owner of the SN 7 has the ability to dictate which Card 5 elements required for membership must match what the owner sets as a prerequisite for admission. Users 1 have the ability to dictate the search privacy of owned the SNs 7, as shown in FIG. 4.

FIG. 4: “Privacy Policy of SNs 7”

Privacy Abilities and Options.

Users 1 who are owners have the ability to make the owned SN 7 discoverable or undiscoverable by search engine. The User 1 owner has the ability to make the owned SN 7 undiscoverable by search engine and discoverable by unique identifier. The User 1 owner has the ability to make the owned SN 7 undiscoverable by search engine and undiscoverable by unique identifier, also preventing the SN 7 from gaining additional members. The User 1 owner has the ability to disallow individual memberships of specific individuals within the owned SN 7 environment as well as individually or collectively block member offers, messages, activity, requests, and approvals. The User 1 member within a joined SN 7 environment has the ability to block individual member messages and activity. The User 1 owner has the ability to approve membership requests to the owned SN 7, providing Card 5 thresholds are met. Users 1 owner of the SN 7 has the ability to deny a “request to join” even if Card 5 thresholds are met. The User 1 owner of the SN 7 also has the ability to allow, allow with approval, or prevent User 1 member features in the owned SN 7 environment including wall posts, photo uploads, video uploads, document uploads, file uploads, data uploads, location features and calendar event posts of User 1 member.

FIG. 4: “Privacy Policy of SNs 7”

Selection of Exclusivity and Privacy Options

Card 5 elements are constantly evolving and will never finish growing. Elements found on the Card 5 include personal information such as user demographics, psychographics, and geographics. Allowing Users 1 to dictate privacy and or exclusivity through selecting Card 5 elements as an owner is novel. Allowing the Card 5 elements to grant admission of a targeted User 1 is novel. Requiring the Card 5 elements a User owner 1 selects as the threshold for admission within a SN 7 is novel. Allowing the Card 5 elements a User 1 owner sets as the only means necessary for admission is a novel privacy policy. Allowing elements required by the User 1 owner for admission coupled with the SN's 7 search privacy is novel. Allowing Card 5 elements to independently act as the threshold for admission is novel.

Selection of Exclusivity and Privacy Options.

19 OPEN: Users 1 have the ability to make an owned SN 7 discoverable by search engine, discoverable by unique identifier and open to membership by anyone who meets set Card 5 thresholds.

20 EXCLUSIVE: Users 1 have the ability to make an owned SN 7 discoverable by search engine, discoverable by unique identifier and require a request to join approval by the owner to become a member from those who meet set Card 5 requirements.

21 PRIVATE: Users 1 have the ability to make an owned SN 7 undiscoverable by search engine, discoverable by unique identifier and require a request to join approval by the owner is required to become a member from those who meet set Card 5 requirements.

22 GHOST: User 1 has the ability to make an owned SN 7 a “Ghost” by gaining unanimous approval off all members rendering the SN 7 undiscoverable by search engine, undiscoverable by unique identifier and unable to acquire any new members.

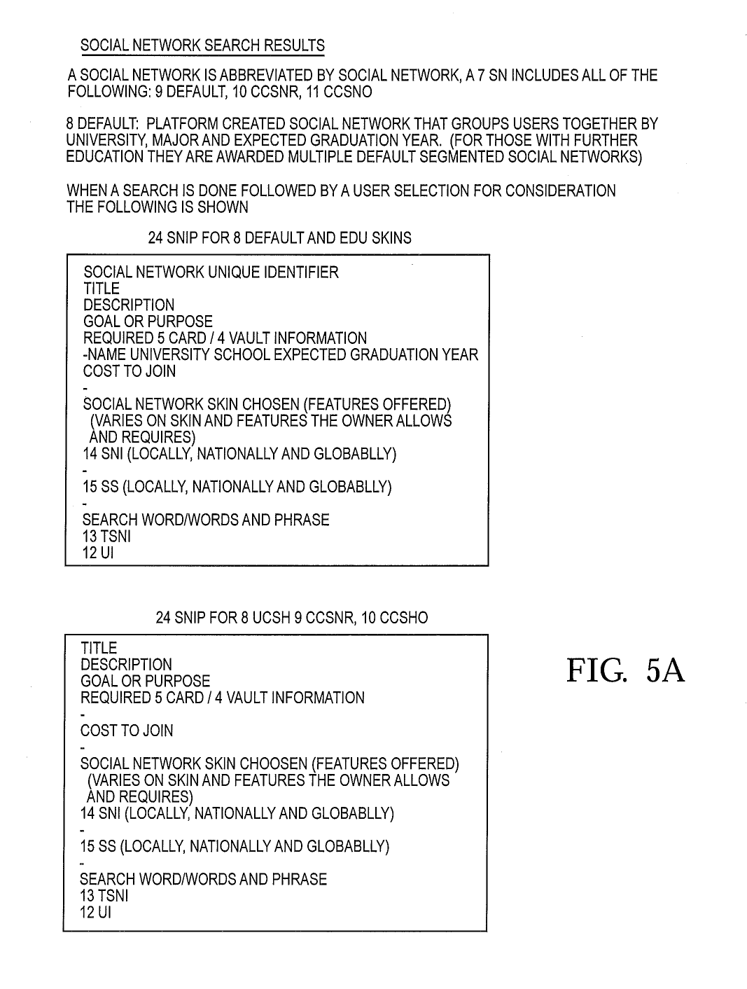

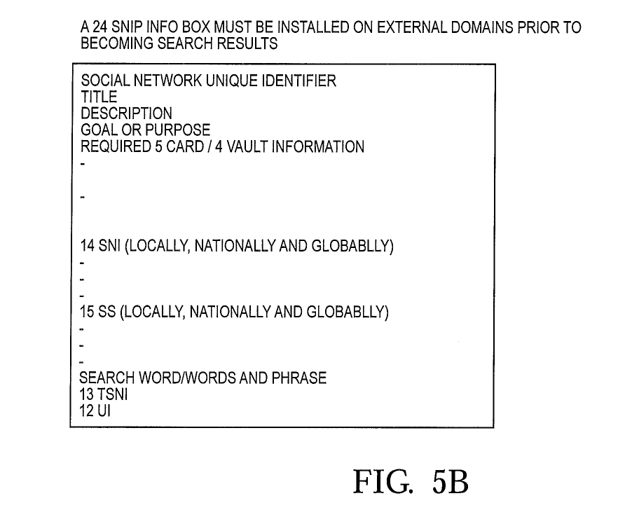

FIGS. 5A-5B: “SNIP 24”

The social network information page or SNIP 24 is shown after a user makes an inquiry and a result is chosen. A Users 1 can see the details of the social network such as but not limited to title, description, purpose, goal, card info required or requested, evaluations, and the privacy setting chosen. Required Card 5 elements necessary for membership the User 1 owner declares will be visible in the SNIP 24. The SNIP 24 can be used with all SNs 7 and eventually be a download allowing third party websites to be included in search results.

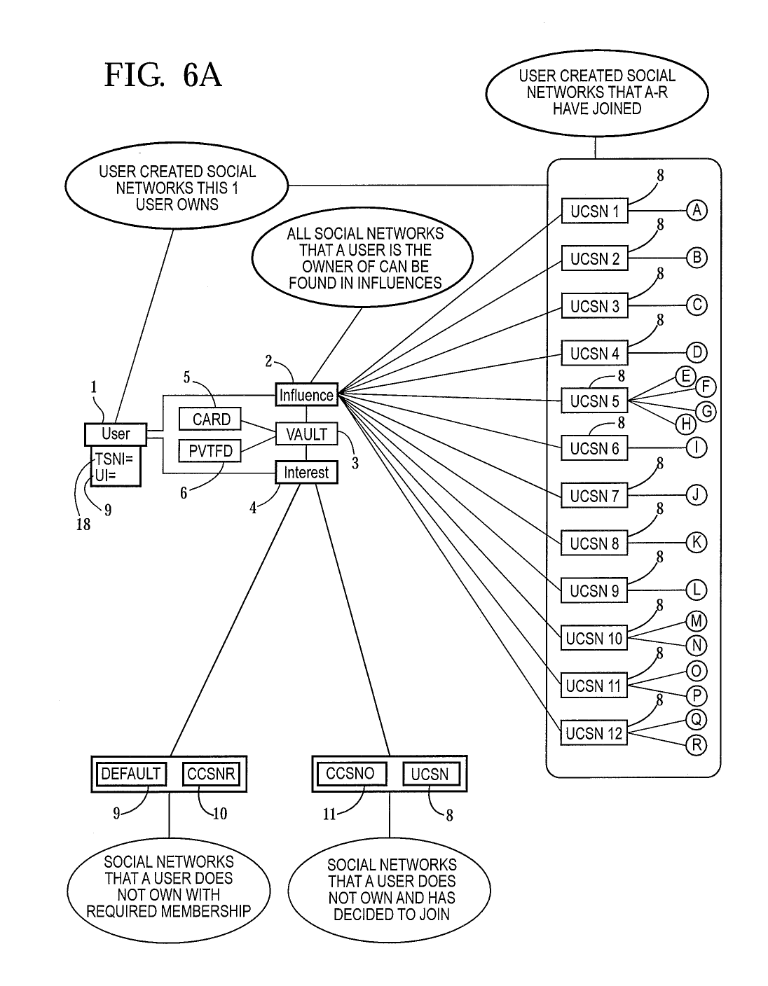

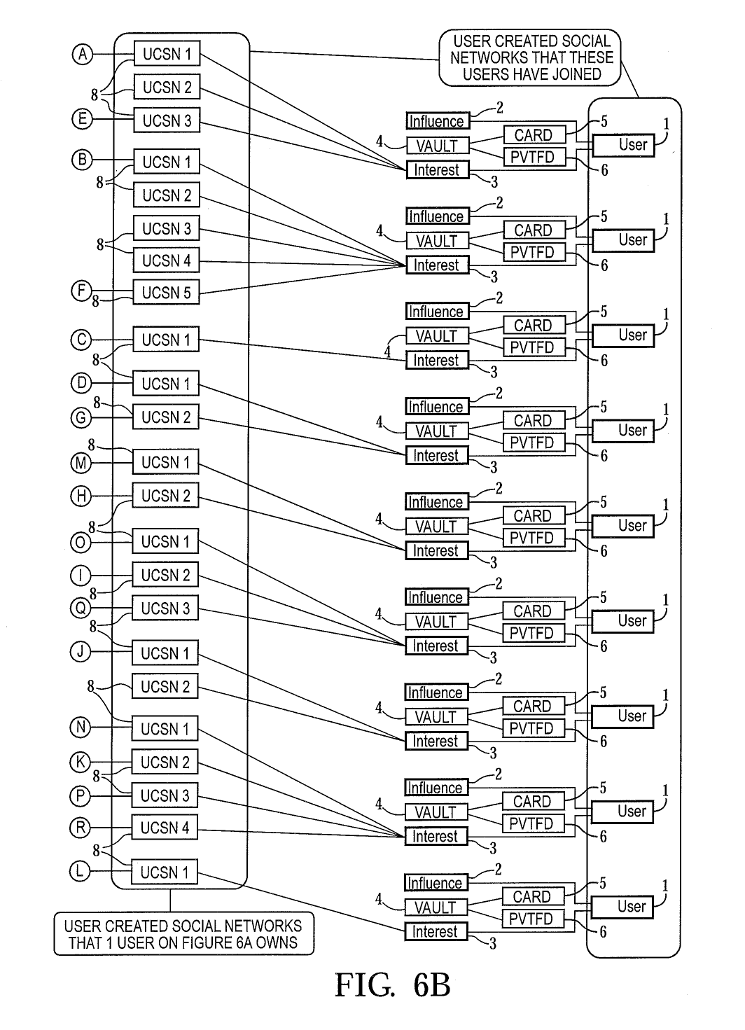

FIGS. 6A-6B: “Influence 2 Graph Details”

The relationship the Influence 2 of the Users 1 has to other Users 1 Interests 3 on the platform is shown in FIGS. 6A-6B. This example shows the User 1 with the UI of 9 and the TSNI of 18. Each of the User's 1 Influence 2 has requirements and/or prerequisites to join. The information that is required to join the SN 7 is pulled from the Card 5 within the Vault 4 and may also include PVTFD 6 information. The information pulled from the Vault 4 and/or Card 5 and/or PVTFD 6 may need to match the desired specifications the owner has set for all the members of a SN 7.

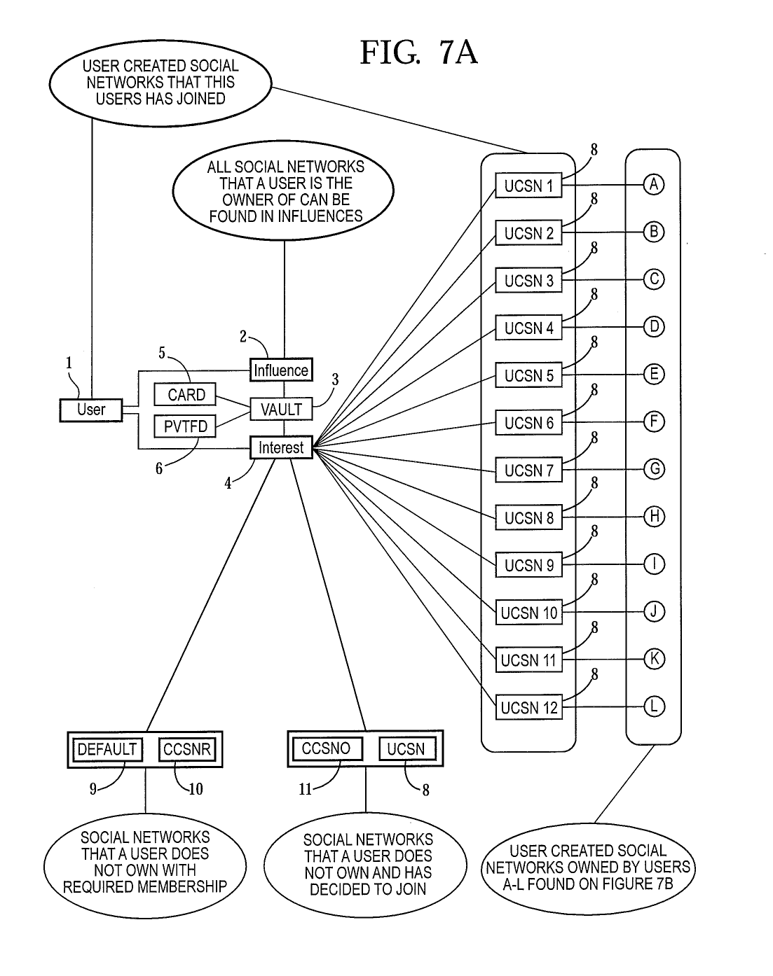

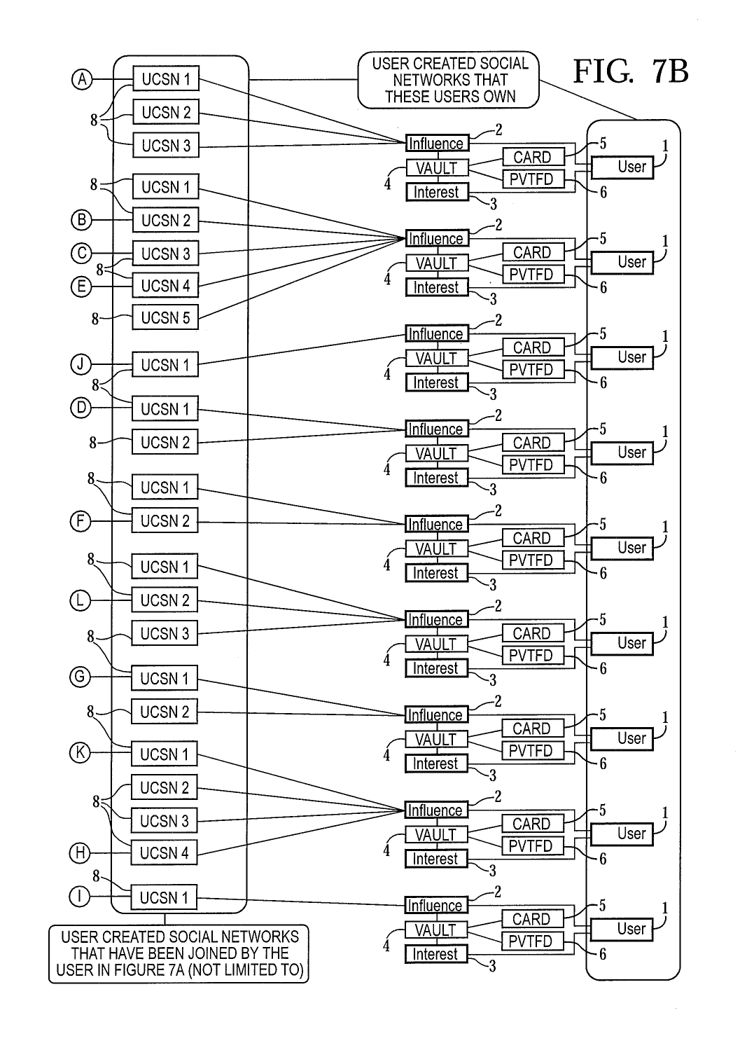

FIGS. 7A-7B: “Interest 3 Graph Details”

This graphical description shows the different SNs 7 a User 1 has joined. The SNs 7 that this User 1 member has joined all have different requirements to join set forth by the owner. The User 1 member who has joined the other Users 1 owned SN 7 has allowed the User 1 owners of those groups access to pre disclosed Card 5 information.

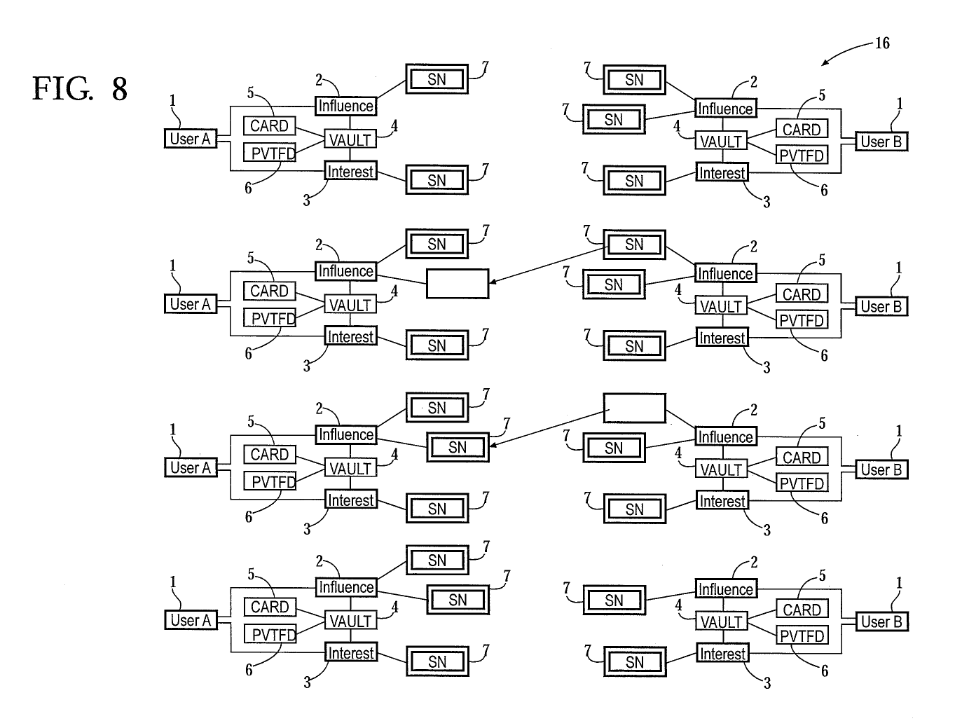

FIG. 8: “Adoption 16”

The Adoption 16 process of the present disclosure is depicted in FIG. 8, and shows a User 1 transferring ownership of a SN 7 to a different User 1.

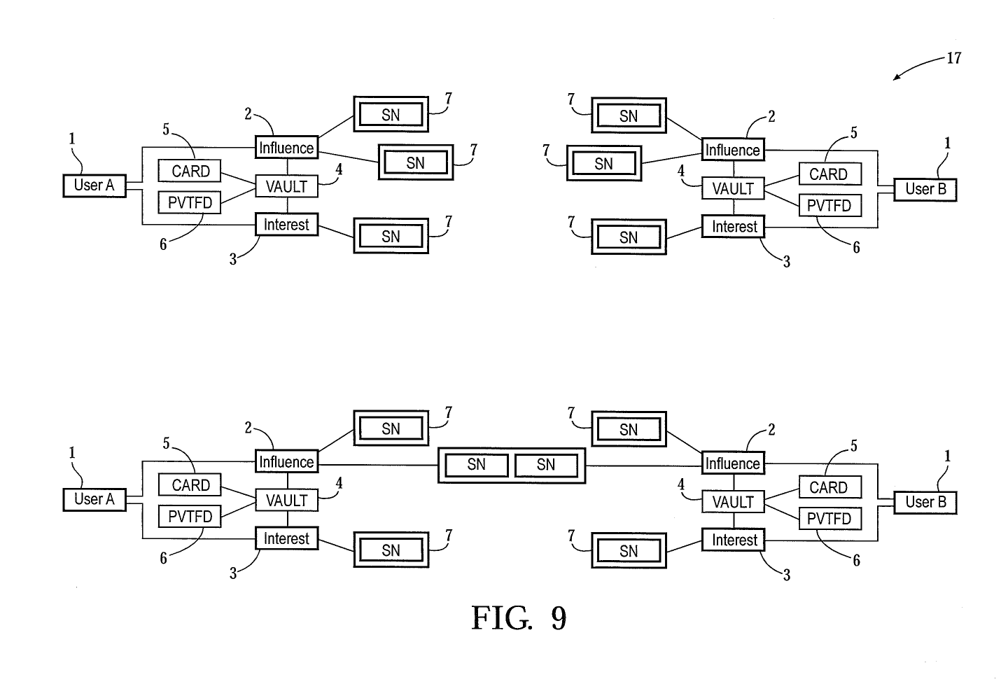

FIG. 9: “Partnership 17”

The Partnership 17 process of the present disclosure is depicted in FIG. 9, and shows an ability of User 1 owners to partner with other User 1 owners within a SN 7 environment. This allows Users 1 to increase their leverage within particular industries.

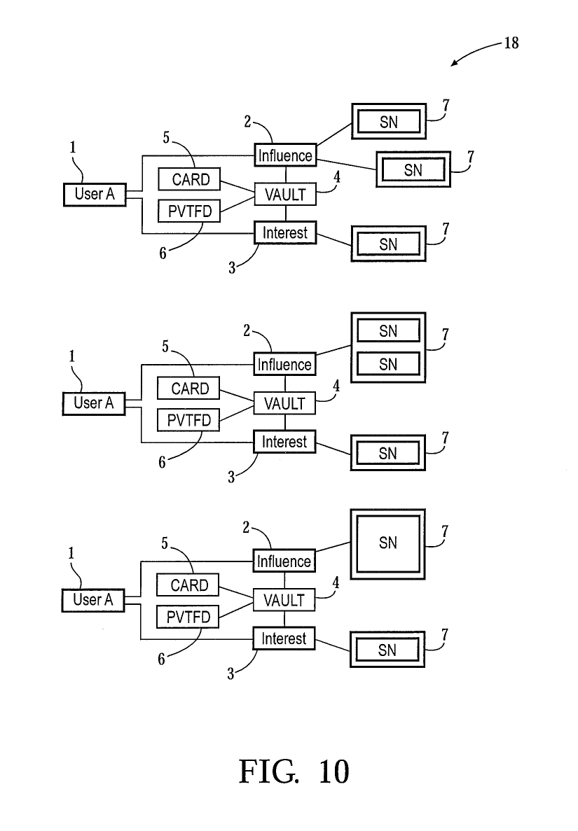

FIG. 10: “Merger 18”

This is a graphical description of the process of combining the members of two previously separate but User 1 owned SN 7 together into one.

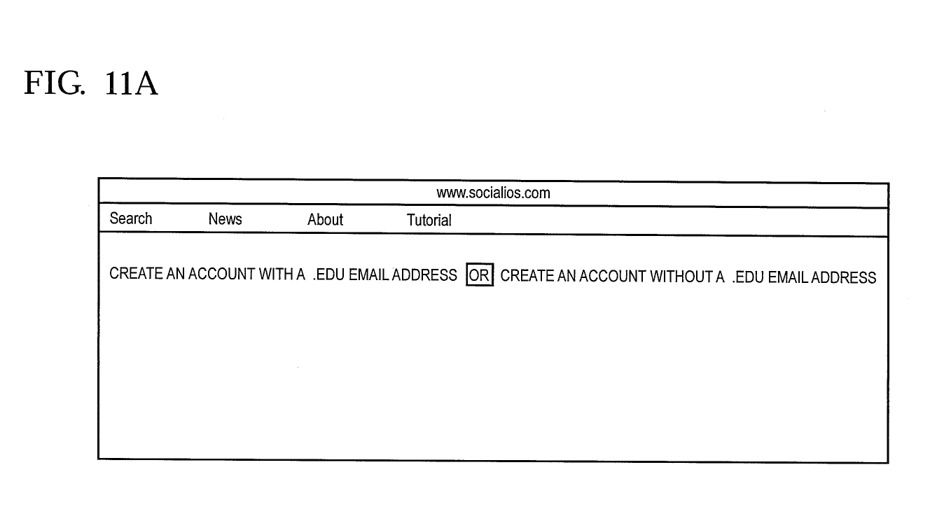

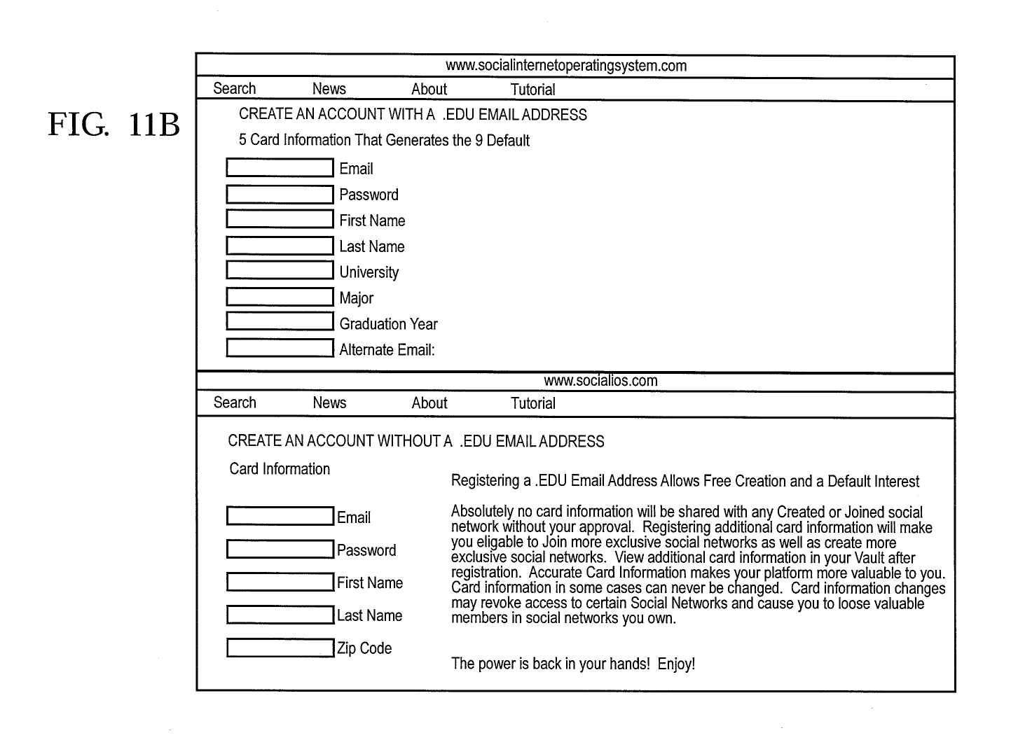

FIGS. 11A-11B: “The EDU Creation Process”

This graphical description shows the elements required from college students when creating and account. Students are then placed within the Default 9 and is a 10 CCSNR giving Users 1 who first log in that register a .EDU email address a default segmented SN 7 they are automatically a member of. The Default 9 SN 7 segments Users 1 by University and Major initially and as the Users 1 base increases it is subject to change to “University Major and Expected Graduation Year”. This process also shows how .EDU and non .EDU email addresses can register for an account but is subject to change. The Card 5 information requested to form the Default 9 will be responsible for the platforms initial growth rate and initial competitive advantage. A User 1 may be assigned or required to enter a unique username when creating an account.

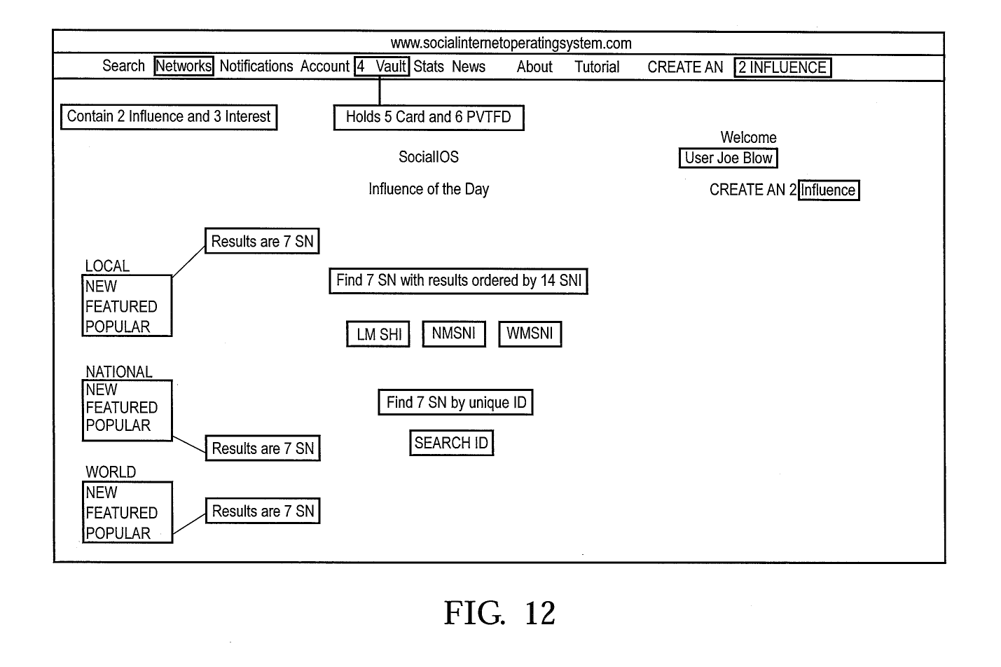

FIG. 12: “Search Engine”

This page shows the structure the social search engine will take on. The social search engine will offer the SN 7 of the day above the search bar. This page will contain a variety of paid advertisement.

This structure is applied to social network profiles and social networks that allow an owner to dictate thresholds and within that environment allows for user-to-user transactions and user-to-multiuser transactions, allowing a User 1 owner to collect or pay out funds to and when members join with requiring payment collection capabilities. In a group buy selection, Social Internet operating system holds the money and until the point and time an adoption from a credible user occurs.

The present disclosure is a search engine and user-created social networking platform that provides people a tool to create their own “end user created group buying networks” in any industry through unique social network structure and competition. This user-created social web development tool provides privacy, exclusivity and validity allowing users to keep their created and joined social networking activities separate and profitable.

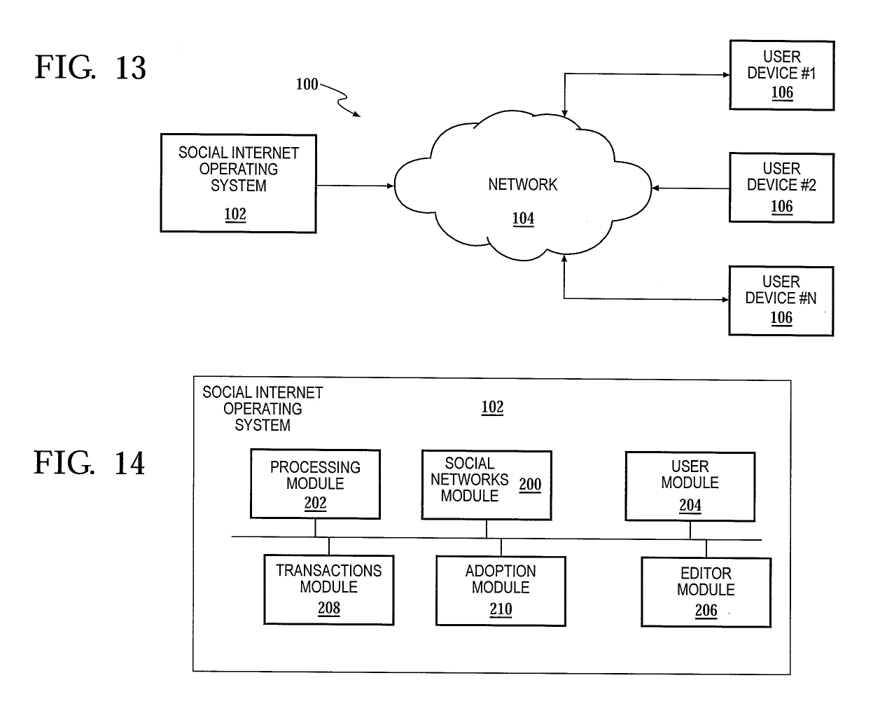

FIG. 13: “Computerized Social Networking System”

Referring now to FIG. 13, the present disclosure includes a computerized social networking system 100. The social networking system 100 includes a social Internet operating system 102 that is in communication via a network 104 with a plurality of user devices 106. For example, the social networking system 100 may be provided in the form of a social networking website on a server that is available to users via personal computers, tablets, mobile phones, and other computer-based devices in communication with the Internet. In other examples, at least a portion of the social networking system 100 may reside on the user devices 106, for example, in the form of downloadable software or application. Other configurations of the social networking system 100 may also be used within the scope of the present disclosure.

FIG. 14: “Social Internet operating system 102”

The Social Internet operating system 102 includes a plurality of modules configured to perform, along or in combination, the method of the present disclosure. Being computer-implemented, it should be understood that the modules may reside on a tangible computer readable storage medium, and be embodied thereon as at least one database, and at least one program of instructions executable by a processor of the Social Internet operating system 102. In a particular embodiment, as shown in FIG. 14, the Social Internet operating system 102 includes at least one of a social network application module 200, a processing module 202, a user module 204, an editor module 206, a transactions module 208, and an adoptions module 210.

The plurality of social network applications 17 are maintained in the social network application module 200. Each of the social network applications 17 has an owner controlling the social network application 17. The owner may be the creator of the social network application 17, or an adoptive user to whom control the social network application 17 has previously been transferred. As described further hereinabove, each of the social network applications 17 also includes the topic having the title, the description, and the goal or purpose defined by the owner.

The processing module 202 is in communication with the plurality of user devices 106 via the network 104, the processor, and each of the other modules of the Social Internet operating system 102. The processing module 202 is configured primarily for user interface and execution of the various functions associated with the modules of the Social Internet operating system 102. The processing module 102 may provide a graphical user interface, for example, employed by the users in interacting with the Social Internet operating system 102 over the Internet. The processing module 202 permits an interaction of the users with the various modules of the computerized social networking system 100.

The processing module 202 may also be used to define the initial default segmentation that the users are shown when logging into the Social Internet operating system 012. For example, each of the users may be shown the plurality of social network applications 7 both owned and joined. In certain examples, the initial segmentation is based upon comparing the virtual user card 5 of the user logging into the Social Internet operating system 102 to other available users' cards 5 on the platform.

Where the Social Internet operating system 012 is employed in an academic environment, the segmentation algorithm may include a grouping together of users by university and major. The segmentation may allow users to search for other users by name within the default segmentation, grouping users together by university and major, and allowing the platforms users to offer invites to fellow colleges or request to join fellow college-created social network applications 7 within the default segmentation provided on the platform. Likewise, all social network applications 7 may be visible and searchable by name universities.

The plurality of accounts for the users is maintained in the user module 204. As described hereinabove, each account includes the vault 4 with the virtual user card 5. The virtual user card 5 has elements of user information that are managed by the user. The vault 4 further has user-provided information 6 including at least one of pictures, videos, text boxes, files, data and uploads that may be associated with at least one of the social network applications 7. The information in the vault of the virtual user card 5 is not shared with any of the social network applications 7 without the user associated with the virtual user card 5 authorizing approval upon joining.

The processing module 202 may also provide search functionality, for purposes of locating desires ones of the social network applications 7 maintained in the social network application module 200. It should be appreciated that the search functionality may alternatively be provided by a separate search module (not shown) in communication with the processing module 202 for displaying search results, as desired.

The search functionality of the processing module 202 permits a plurality of users to search and provides search results when an inquiry is made. The search results are a listing of social network applications 7, for example. The search results may be ordered by the amount of members each of the located social network applications 7 has, for example, where the located social network applications 7 have the same or similar search words declared, from greatest to least.

In a particular embodiment, only members within a predetermined geographic location of the search inquiry made can influence the amount of members a particular social network application 7 has, with results being ordered from greatest to least. In another embodiment, only members located within the same country of the inquiry made can influence the amount of members a social network application 7 has, with results being ordered from greatest to least. Search results may also be limited to social network applications 7 created within a 100 mile radius of the search inquiry made, for example. In another example, the search results are limited to social network applications 7 created within the same country of origin as the search inquiry made.

It should be appreciated that, using the editor module 206, each user owner has the ability to make owned social network applications 7 visible in inquiry results made within specific geographic locations. For example, the user owner of the social network application 7 has the ability to have the social network application 7 excluded from search results of inquiries made within specific declared geographic locations. The search inquiry made in the search bar of the Social Internet operating system 102 may show results of webpages that have been ordered, for example, from greatest to least, by the amount of links the webpage has to social network users.

In illustrative embodiments, the search engine of the Social Internet operating system 102 will take the total amount of social network profile links on a page the website wishes to record and presents the user making the inquiry with the options of searching by specific social network user profile links, ordering results from greatest to least. The Social Internet operating system 102 may also present a running total of all social network profile links on the page or website the owner wishes to record.

An evaluation is placed on social network applications 7 that include SNI and SS, and also an evaluation is placed on platform Users as well. These evaluation are for search purposes and social network purchasing opportunities. Evaluations are also placed on social network users that include TSNI, which is the total amount of members located in all a users owned social networks. A UI evaluation may also be placed on social network users which is the total amount of users a user has access to in all owned influences.

The searching of the social network applications may take advantage of the calculated SNI and SS for each of the social network applications. It should be appreciated that each of the social network applications 7 has a social network Influence (SNI) and a social stock (SS) evaluation. The SNI is the total number of members of one of the social network application 7 and the SS is the SNI divided by the total amount of social networks created with the same or similar search words declared. For example, where results of the search contain search words found in the title, description, goal or purpose, the search results may be ordered by SNI from greatest to least.

The searches permitted by the processing module 202 may be defined as local searches, national searches, and world searches. The local search may have results that are a listing of social network applications with the same search words declared ordered by SNI from greatest to least, but limiting the SNI to include only members within a predetermined geographic location to the search inquiry made The national search may have results that are a listing of social network applications with the same search words declared ordered by SNI, but limiting the SNI to include only members within the same country of origin as the search inquiry made. The world search may have results that are social network applications with the same search words declared ordered by SNI from greatest to least, without limitation to local or national origin of the social network applications.

In other embodiments, a search all may be performed in which the search results are a listing of social network applications with the same search words declared ordered by SNI without limitation to local, national or world origin of the social network applications. The SNI results are calculated individually in this search: locally, nationally; and globally, and then ordered by SNI from greatest to least. The results of the local search, the national search, and the world search are factored individually using a different denominator that represents a total number of social, network applications in each of the searches.

The evaluation of each social network application 7 may further include measurements of advertisement, adoption, and corporate offers. The evaluation may be based on the SNI for each social network application 7, and can fluctuate in value based on industry. Each user may also have a total social network influence (TSNI) which is a sum of SNI for each social network application owned by the user. Each user may further have a user influence (UI) which is a sum of users to which the user has access to as the owner of one of the social network applications. It should be appreciated that users who belong to multiple social network applications of the owner are counted only once for purposes of UI.

The editor module 206 is configured to permit the users, and particularly the owners, of the social network applications 7 to edit or update the social network applications 7 maintained in the social networks module 200. For example, the editor module 206 allows the owner to set the threshold requirements for each of the users joining as the member of the social network application 7 controlled by the owner. In other examples, the editor module 206 may allow the users to share certain information in the vault 4 of the user with other users of the system 100. The editor module 206 may also be used for making other updates, changes, or revisions to the social network applications 7, as desired.

The adoption module 210 is configured to allow the adoption of the one of the social network applications 7 as described further hereinabove, for example, in FIG. 8. Where the adoption occurs, using the adoption module, control of the social network application 7 is transferred from the owner to one of the users. The adoption module 210 may also be used for partnering of social network applications 7, as shown in FIG. 9, and for merging of social network applications 7, as shown in FIG. 10, as desired. A skilled artisan should understand that separate modules may be provided for the partnering and merging features of the platform within the scope of the present disclosure.

It should also be understood that the Social Internet operating system 102 of the disclosure may includes the transaction module 208. The transaction module 208 may have a plurality of transaction or charge accounts that are associated with the plurality of the accounts for the users, for example, in the user module 204. The transaction accounts are configured to receive deposits from the users and transfer funds between the transaction accounts, as desired.

In one embodiment, the user may be charged either an initial membership fee or a periodic fee (e.g., weekly, monthly, annual, etc.) to maintain its status as member of a particular social network application 7. In another embodiment, the user may be charged during an operation such as the adoption, the partnership, and the merger as described hereinabove. The transactions accounts may also be maintained (e.g., with additional funds added by credit card or an online payment service) by the user with the transaction module 208. The transaction accounts may also permit deposits and withdraws to bank accounts or to a bank card. The transaction account verifies identity and allows the User 1 a unique identifier showing potential members that the owner is a verified User 1.

In certain examples, the owner can charge one of the users for joining the social network application 7 of the owner, the charge for joining being withdrawn from the funds of the transaction account of the one of the users joining the social network application 7. The owner may also charge to advertise in the form of a community post, including a picture and a description, which is seen by all users who have joined the one of the social network applications 7 controlled by the owner. In other examples, the owner can charge others to advertise in the form of a picture or pictures that are seen by all users who have joined the one of the social network applications 7, with tally capabilities that tracks picture selection from members for various purposes.

Where the adoption module 102 is used, the owner can charge the adoptive user for the adoption of the social network application 7. Where the adoptive user is one of a member of the social network application 7 being adopted, and not a member of the social network application 7 being adopted, the adoptive user may be required to meet adoption requirements set forth by the owner. It should be appreciated that the adoption requirements may include at least one of financial payment prior to the adoption. Using the transaction module 208, the owner may select each of a cost of adoption, a cost for new members, and a cost of an advertisement, as desired.

The transaction module 208 may also permit a variety of other types of charges within the scope of the present disclosure. For example, the individual social network applications 7 of the Social Internet operating system 102 may be time-limited and expire unless a renewal fee is paid by the user owners. The Social Internet operating system 102 may chare if the user owner would like to purchase the unique identifier for the created or owned social network application 7. To feature an owned social network application 7 in search results, there may be a feature charge to the transaction account of the user owner. If a user wants their social network application 7 or unique identifier to be featured above the search bar, for example, there may be a fee charged to the transaction account. An offer to visit or join the social network application 7 may also be sent to a target marker the user owner would like to pursue, and a fee may be charged to the transaction account for this service. When uses who want their owned social network application 7 to be included and seen within other users' interest after logging in, even if the user is not a member with membership optional, a further fee may be charged. For every transaction, the Social Internet operating system may also charge a percentage-based transactional fee. Other types of transactions and ways for using the transaction module 208 are also contemplated and within the scope of the present disclosure.

One of ordinary skill in the art should understand that other types of modules, configured to perform the method of the present disclosure, are also contemplated and may be provided in the Social Internet operating system 102, as desired.

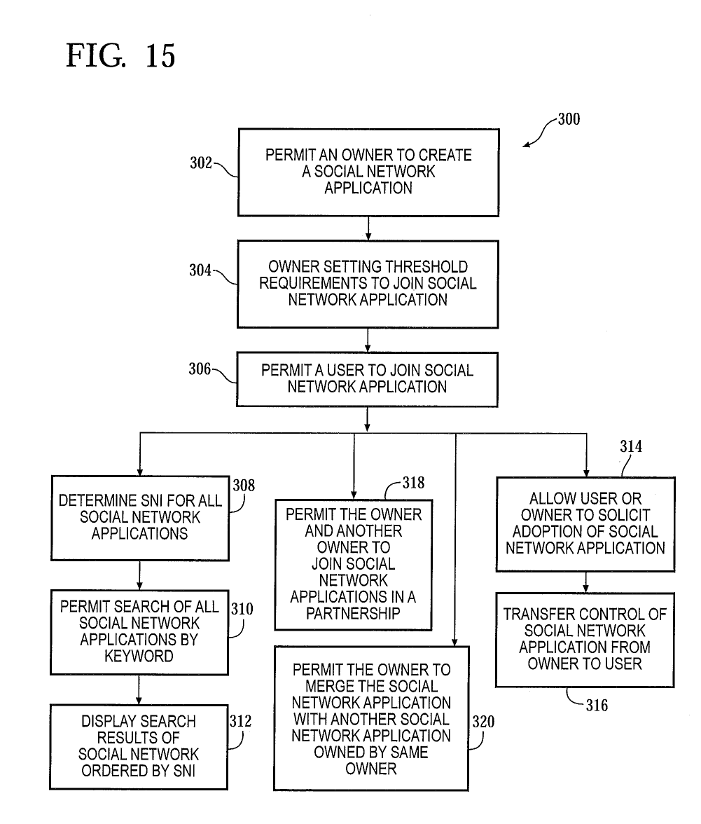

FIG. 15: Computer implemented social networking method 300.

The present disclosure includes an exemplary computer implemented social networking method 300. The method 300 includes a step 302 of permitting an owner to create the social network application 7 in the Social Internet operating system 102. The owner is then allowed in a step 304 to set the threshold requirements for each of the users joining as a member of the social network application 7 controlled by the owner. In a step 306, the user is permitted to join as the member the social network application 7 controlled by the owner. In order to join, the elements of the user information on the virtual user card 5 of the user satisfy the threshold requirements set by the owner.

In one embodiment, the method 300 may further include a search of the social network applications 7, for example, as has been described further hereinabove. As shown in step 308, the SNI may be determined for all of the social network applications 7 in the Social Internet operating system 102. Where a search of all of the social network applications 7 by keyword is performed in a step 310, the search results may subsequently be displaying in the graphical user interface, ordered by the calculated SNI, in a step 312.

In another embodiment, the method 300 may further includes a step 314 in which a potentially adoptive user or the owner may solicit the adoption of the owner's social network application 7. In a step 316, where the adoption is agreed upon and all conditions set forth by the owner are met, the owner may transfer control of the social network application 7 from the owner to the adoptive user.

In a further embodiment, the method 300 may include a step 318 of permitting the owner and another owner to joint their respective social network applications 7 in a partnership. In the partnership, the social network applications 7 are linked or visually intermeshed and may be viewed together by users. In another embodiment, the method 300 may include a step 320 of permitting the owner to merge the owner's social network application with another social network application 7 also owed by the owner, in an operation known as a merger. Like a partnership, the owner's merged social network applications 7 are linked or visually intermeshed and may be viewed together by users.

Advantageously, the present social networking system and method facilitates competition through evaluating of a network of individuals having like or similar interests, with users being able to dictate prerequisite authorization for member acceptance. It is thereby ensured that members with the desired attributes are the participants of the social network applications.

While certain representative embodiments and details have been shown for purposes of illustrating the invention, it will be apparent to those skilled in the art that various changes may be made without departing from the scope of the disclosure, which is further described in the following appended claims.

What is claimed is:

1. A computer implemented social networking method, the method comprising the steps of:
maintaining in a computer system a plurality of social network applications and a plurality of accounts for users, each of the social network applications having an owner controlling the social network application and including a topic having a title, a description, and a goal or purpose defined by the owner; and
allowing the owner to set the threshold requirements for each of the users joining as a member of the social network application controlled by the owner.

2. The method of claim 1, wherein each of the users has a vault that is maintained in the computer system with a virtual user card, the virtual user card having elements of user information that are managed by the user, and wherein the vault further has user-provided information including at least one of pictures, videos, text boxes, files, data and uploads that may be associated with at least one of the social network applications.

3. The method of claim 2, wherein the threshold requirements are compared to the elements of the user information on the virtual user card.

4. The method of claim 3, further including a step of permitting the user to join as the member the social network application controlled by the owner where the elements of the user information on the virtual user card of the user satisfy the threshold requirements set by the owner.

5. The method of claim 4, wherein upon logging into the computer system the user is shown on a graphical user interface the plurality of social network applications with a default segmentation based upon a comparison of elements of the virtual user card of the user logging into the computer system to the topics of the plurality of social network applications.

6. The method of claim 4, wherein the owner is permitted to charge the user a membership fee to be the member of the social network application.

7. The method of claim 6, wherein the membership fee is one of an initial fee and a periodic fee charged to the member.

8. The method of claim 1, wherein the owner is permitted to declare the elements of the user information that are required to join, the elements of the user information that are to be shown only to the owner upon permitting the user to join as the member, the elements of the user information that are to be shown to all of the members upon permitting the user to join as the member, and the elements of the user information that must match the threshold requirements for the user to be permitted to join as the member.

9. The method of claim 1, further including a step of permitting the owner to set a privacy policy for the social network application controlled by the owner, wherein the social network application may be set to each of open, exclusive, private, and ghost,
wherein the social network application under the open privacy policy is discoverable by search engine and discoverable by unique identifier, and open to membership by any of the users who meets the threshold requirements,
wherein the social network application under the exclusive privacy policy is discoverable by search engine, discoverable by unique identifier, and open to membership by any of the users who meets the threshold requirements and is a recipient of an invitation or approval to join by the owner,
wherein the social network application under the private privacy policy is undiscoverable by the search engine, discoverable by unique identifier, and open to membership by any of the users who meets the threshold requirements and is a recipient of an invitation or approval to join by the owner, and
wherein the social network application under the ghost privacy policy is undiscoverable by both search engine, undiscoverable by unique identifier, and does not permit any new members to join, the ghost privacy only permitted by consent of all of the members of the social network application.

10. A computer implemented social networking method, the method comprising the steps of:
maintaining in a computer system a plurality of social network applications and a plurality of accounts for users, each of the social network applications having an owner controlling the social network application and including a topic having a title, a description, and a goal or purpose defined by the owner; and
permitting a search of the social network applications by keyword relative to the title, the description, and the goal or purposes; and
displaying the search results in a graphical user interface, the search results including a listing of the social network applications having one of the title, the description, and the goal or purpose matching the keyword searched.

11. The method of claim 10, further including a step of calculating a social network influence (SNI) for each of the social network applications, wherein the SNI is an amount of members of the social network application.

12. The method of claim 11, further including a step of calculating a total social network influence (TSNI) for each of the social network applications, wherein the TSNI includes the amount of users accessible through the associated social network application.

13. The method of claim 12, wherein the listing of the social network applications is presented in a graphical user interface and ordered from greatest to least by one of SNI and TSNI.

14. The method of claim 13, wherein only the members who are within a predetermined geographical location relative to the origin of the search inquiry made affect the SNI.

15. The method of claim 14, wherein the step of evaluating each of the social network applications for the SNI is conducted at least one of locally, nationally and globally.

16. A computer implemented social networking method, the method comprising the steps of:
maintaining in a computer system a plurality of social network applications and a plurality of accounts for users, each of the social network applications having an owner controlling the social network application and including a topic having a title, a description, and a goal or purpose defined by the owner; and
allowing an adoption of the social network application of the owner by one of the users, whereby the controlling of the social network application is transferred by the adoption from the owner to the one of the users.

17. The method of claim 17, wherein the owner is permitted to set forth adoption requirements that must be met by the one of the users prior to the adoption of the social network application of the owner by the one of the users.

18. The method of claim 18, wherein the one of the users is charged a transaction for by the owner for the adoption of the social network application.

19. A computerized social networking system, comprising:
a social network application module having a plurality of social network applications, each of the social network applications having an owner controlling the social network application and including a topic having a title, a description, and a goal or purpose defined by the owner;
a user module having a plurality of accounts for users, each account including a vault with a virtual user card, the virtual user card having elements of user information that are managed by the user, and the vault further having user-provided information including at least one of pictures, videos, text boxes, files, data and uploads that may be associated with at least one of the social network applications;
an editor module allowing the owner to set the threshold requirements for each of the users joining as a member of the social network application controlled by the owner;
an adoption module configured to allow an adoption of one of the social network applications, whereby control of the social network application is transferred by the adoption from the owner to one of the users;
a transaction module having a plurality of transaction accounts associated with the plurality of the accounts for the users, and configured to receive deposits from the users and transfer funds between the transaction accounts;
a processor; and
a processing module in communication with a plurality of user devices via a network, the processor, and each of the social network application module, the user module, the editor module, the adoption module, and the transaction module, the processing module permitting an interaction of the users with each of the social network application module, the user module, the editor module, the adoption module, and the transaction module.

20. A computer readable storage medium tangibly embodied thereon a program of instructions executable by a processor for performing a computer-implemented social networking method, the method comprising:
maintaining in a computer system a plurality of social network applications and a plurality of accounts for users, each of the social network applications having an owner controlling the social network application and including a topic having a title, a description, and a goal or purpose defined by the owner; and
at least one of i) allowing the owner to set the threshold requirements for each of the users joining as a member of the social network application controlled by the owner, ii) permitting a search of the social network applications by keyword relative to the title, the description, and the goal or purposes, and displaying the search results in a graphical user interface, the search results including a listing of the social network applications having one of the title, the description, and the goal or purpose matching the keyword searched, and iii) allowing an adoption of the social network application of the owner by one of the users, whereby the controlling of the social network application is transferred by the adoption from the owner to the one of the users.
